(19) United States
(12) Patent Application Publication
(10) Pub. No.: US 2010/0250223 A1
(43) Pub. Date: Sep. 30, 2010

(54) SEMICONDUCTOR CIRCUIT DETERIORATION SIMULATION METHOD AND COMPUTER PROGRAM MEDIUM

(75) Inventors: Daisuke Hagishima, Kawasaki-shi (JP); Kazuya Matsuzawa, Tokyo (JP); Yuichiro Mitani, Miura-gun (JP); Shigeto Fukatsu, Yokohama-shi (JP); Kouichirou Inoue, Yokosuka-shi (JP)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Kabushiki Kaisha Toshiba

(21) Appl. No.: 12/652,434

(22) Filed: Jan. 5, 2010

(30) Foreign Application Priority Data
Mar. 25, 2009 (JP) 2009-073907

(51) Int. Cl. G06F 17/50

(52) U.S. Cl. 703/14

(57) ABSTRACT

A semiconductor circuit deterioration simulation method for a circuit including MOSFETs includes inserting a dynamic voltage source associated with a fluctuation in voltage/current characteristics into each gate terminal of a plurality of MOSFETs in series, calculating dynamic deterioration amounts of the plurality of MOSFETs by performing circuit simulation and calculating a dynamic deterioration amount, and repeating the above processing to perform the circuit deterioration simulation over the long term.

### CROSS-REFERENCE TO RELATED APPLICATIONS

This application is based upon and claims the benefit of priority from prior Japanese Patent Application No. 2009-073907, filed Mar. 25, 2009, the entire contents of which are incorporated herein by reference.

### BACKGROUND OF THE INVENTION

1. Field of the Invention

The present invention relates to a deterioration simulation method for a semiconductor circuit and a computer program medium having this method recorded therein.

2. Description of the Related Art

As high integration of semiconductor circuits advances, miniaturization of MOSFETs progresses at an accelerated pace. That is because switching speed is improved or drain current is increased by the miniaturization. However, since a power supply voltage is not necessarily lowered in accordance with the miniaturization, a high electric field region tends to be produced in a transistor as the miniaturization advances. Therefore, deterioration in reliability is becoming serious with each new generation. Bias temperature instability (BTI) as a typical deterioration phenomenon for MOSFETs occurs because of intensification of a gate insulating film electric field. Further, hot carrier deterioration occurs because of intensification of a lateral electric field between a source and a drain. All these phenomena raise a threshold voltage shift or a reduction in drain current.

The BTI is a transistor deterioration phenomenon which advances when a MOSFET is on, and the absolute threshold value increases or the drain current decreases with time. This phenomenon occurs in a pMOSFET alone as a transistor in which a gate insulating film is a silicon oxide film or a silicon nitride film, but this phenomenon occurs in both an nMOSFET and a pMOSFET as a transistor using a high-dielectric constant (high-k) gate insulating film. The BTI which occurs in an nMOSFET is generally called positive bias temperature instability (PBTI), and the BTI which occurs in a pMOSFET is generally called negative bias temperature instability (NBTI). Hot carrier deterioration is a phenomenon wherein a carrier enters a high-energy state to be trapped in a gate insulating film because of a lateral electric field between a source and a drain. In this phenomenon, the absolute value of the threshold voltage increases or the drain current decreases with time like the NBTI.

To guarantee a circuit operation, evaluating reliability of a MOSFET constituting a circuit is important. However, since the reliability cannot be directly measured, a later-explained reliability evaluation method using a duty ratio and a “circuit reliability simulation technology” obtained by developing this method have been utilized. This is a method of estimating a deterioration amount and deteriorated circuit characteristics of each device from a terminal voltage and a terminal current calculated by circuit simulation using, for example, Simulation Program with Integrated Circuit Emphasis (SPICE).

As the circuit reliability simulation technology, BERT which is a circuit reliability simulator developed in University of California at Berkeley in U.S. is known (see “Berkely Reliability Tools—BERT”, R. H. Tu, et al, IEEE Trans. Computer-Aided Design of Integrated Circuits and Systems, vol. 12, No. 10, October, 1991). As shown in FIG. 2 of this literature, an input file (an input deck) in which a circuit configuration is specified and a parameter file (device parameters) utilized for a simulation are first prepared. It is to be noted that the influence of the BTI or the hot carrier deterioration is not reflected in the device parameters currently in effect. How parameters utilized for SPICE simulation vary because of the BTI or the hot carrier deterioration is specified in reliability parameters. Further, after a pre-processor prepares for the SPICE simulation, circuit simulation is carried out in the SPICE. At this time, circuit characteristics in an ideal state without considering deterioration are obtained. Furthermore, a post-processor calculates a deterioration amount of each MOSFET in the circuit based on a result of the circuit simulation, and a new SPICE simulation parameter file having this deterioration calculation result reflected therein is generated. Using the parameter file generated by the post-processor enables executing the circuit simulation having deterioration of each MOSFET in the circuit reflected therein.

Moreover, a technology that incorporates a transistor deterioration model having the NBTI reflected therein into a processor and utilizes parameters after deterioration to again execute the circuit simulation is disclosed (see JP-A 2008-225961 [KOKAI]). Additionally, there is also disclosed a method for performing a circuit simulation after elapse of time by forming a table showing continuous deterioration statuses of devices caused to deteriorate by a factor such as a hot carrier and fetching the formed table (see U.S. Pat. No. 7,292,968). However, the technologies in both the patent documents do not deal with the possibility that each MOSFET is caused to deteriorate during transient analysis.

As explained above, the circuit reliability simulation based on the BERT is very effective for designing a circuit since a threshold voltage shift of each MOSFET in the circuit can be calculated. However, the known technique based on the BERT has the following technical problems.

A first technical problem is that parameters of the circuit simulation are changed to reflect deterioration of each MOSFET or each TFT in the simulation in a conventional art. In the above-described BERT, a parameter file in which a deterioration amount (e.g., a threshold voltage shift or a drain current deterioration ratio) of each device is reflected is generated by the post-processor, and this file is utilized to simulate circuit characteristics after the deterioration. However, according to this method, parameters to which a threshold voltage shift or drain current deterioration due to the BTI or the hot carrier deterioration is reflected must be accurately checked from many pieces of experimental data in advance. In general, since the number of parameters used for the circuit simulation is very large, a tremendous cost and time are required.

A second technical problem is that a duty ratio is fixed to estimate circuit characteristics after long-term deterioration in the conventional art. The duty ratio is a ratio of a change in threshold value of a MOSFET under an AC operation and a change in threshold value of the same under a DC operation at a time t, but details thereof will be explained later. In the conventional art, the circuit characteristics after deterioration are estimated on the assumption that the duty ratio is fixed at an initial stage of a circuit operation and even after 15 years. This means that a threshold value or a drain current of the MOSFET after 15 years is the same as that estimated on the initial stage of the circuit operation. However, in an actual circuit, a voltage or a current value at each terminal varies from a value estimated on the initial stage of deterioration with deterioration of each MOSFET in the circuit. That is, the duty ratio of each MOSFET in the circuit varies dynamically (in terms of a time function) with deterioration. This reduces an estimation accuracy for the circuit reliability simulation and makes designing the circuit more difficult.

Therefore, realization of the circuit reliability simulation technology that can reflect deterioration of each device (a MOSFET or a thin-film transistor [TFT]) constituting a circuit in the circuit simulation without changing parameters for the circuit simulation and can dynamically reflect an estimated deterioration amount of each device in the circuit simulation and the simulation method that enables execution of the circuit reliability simulation in a short time has been demanded.

### BRIEF SUMMARY OF THE INVENTION

According to a first aspect of the invention, there is provided a semiconductor circuit deterioration simulation method for a circuit using a computer including a pre-processor, a main processor, and a post processor, comprising:

creating by the pre-processor, a second input file pre-processed to enable inserting a dynamic voltage source associated with a fluctuation in voltage/current characteristics into each gate terminal of the plurality of MOSFETs in series, based on a first input file having the circuit including a plurality of MOSFETs specified therein, and a first deterioration calculation condition file including a dynamic deterioration model associated with elapse of a time, to send the second input file and the first deterioration calculation condition file to the main processor;

performing first circuit simulation with respect to the second input file by the main processor and calculating a dynamic deterioration amount after elapse of a short time dt from a time tᵢ (i=an integer greater than or equal to 0) of the plurality of MOSFETs based on the dynamic deterioration model by using the first deterioration calculation condition file to create a third input file, to send the third input file to the post processor;

performing, by the post processor, an estimation calculation of a dynamic fluctuation amount at a time tᵢ₊₁ (where tᵢ₊₁−tᵢ>dt) by extrapolation based on the third input file to create a second deterioration calculation condition file, to feed back the second deterioration calculation condition file to the main processor;

calculating, by the main processor, dynamic deterioration amounts of the plurality of MOSFETs at tᵢ₊₁ to tᵢ₊ᵢ+dt with contents in the second deterioration calculation condition file based on the dynamic deterioration model, and then carrying out second circuit simulation having the dynamic deterioration amount reflected therein, to send the post processor;

repeating processing from the estimation calculation based on the extrapolation to the second circuit simulation by the post processor until tᵢ reaches a simulation target time t_{final}; and outputting from the post processor an output file in which the second circuit simulation is reflected when tᵢ reaches t_{final}.

According to a second aspect of the invention, there is provided a computer program medium having a program executed by a computer recorded therein, the program including a circuit deterioration simulation method for a circuit including MOSFETs, and the method including the steps of the circuit deterioration simulation method of the first aspect.

### BRIEF DESCRIPTION OF THE SEVERAL VIEWS OF THE DRAWING

FIG. 1 is a graph for explaining a duty ratio;

FIG. 2 shows a circuit example using MOSFETs;

FIG. 3 is a symbol diagram of a single MOSFET utilized for DC evaluation;

FIGS. 4A and 4B are schematic views for explaining a circuit deterioration simulation method according to a first embodiment, where FIG. 4A is an explanatory view of a function that represents a dynamic deterioration amount of the MOSFET and FIG. 4B is a view for explaining inserting this function as a voltage source into a gate of the MOSFET;

FIG. 5 is a table in which how to take a time axis in transient analysis according to the first embodiment is compared with that in the conventional art;

FIG. 6 is a graph for explaining a deterioration amount calculation method according to the first embodiment;

FIG. 7 is a schematic view showing a configuration and a flow of the circuit deterioration simulation method according to the first embodiment;

FIG. 8 is a flowchart showing processes executed by a pre-processor;

FIG. 9 is a flowchart showing processes executed by a main processor;

FIG. 10 is a flowchart executed by a post-processor;

FIG. 11 is a flowchart for explaining a deterioration amount extrapolation method in the first embodiment;

FIG. 12 is a graph for explaining a fitting function calculation method;

FIG. 13 is a circuit diagram of a MOSFET circuit used for evaluating an effect of the embodiment;

FIG. 14 is a graph showing the effect according to the first embodiment in which ΔVth and ΔID/ID in each of NBTI and a hot carrier in a pMOS and a hot carrier in an nMOS are represented in the form of ratios with respect to values obtained by a conventional method;

FIG. 15 is a view in which delay in each of a rising edge and a falling edge of an output waveform due to deterioration in a pMOSFET and an nMOSFET is compared with that before deterioration and that after 15 years by the simulation;

FIG. 16 is a circuit diagram of an inverter circuit used for evaluation the effect according to the first embodiment;

FIG. 17 is a view for explaining how a starting time of the circuit simulation dominates a calculation time of a CPU in the conventional art;

FIG. 18 is a view showing that a CPU operating time in the embodiment is superior to that in the conventional art;

FIG. 19 is a schematic view for explaining a deterioration amount extrapolation method in a second embodiment;

FIG. 20 is a flowchart of the extrapolation method according to the second embodiment;

FIG. 21 is a graph showing an effect of the second embodiment in which ΔVth and ΔID/ID in each of NBTI and a hot carrier in a pMOS and a hot carrier in an nMOS are represented as ratios with respect to values obtained by the conventional method; and

FIG. 22 is a view in which delay in each of a rising edge and a falling edge of an output waveform due to deterioration of a pMOSFET and an nMOSFET is compared with an initial value and a value after 15 years by the simulation in the second embodiment.

### DETAILED DESCRIPTION OF THE INVENTION

Prior to a description of embodiments, the duty ratio will be explained in more detail. In order to guarantee a circuit operation, the BTI or the hot carrier deterioration with respect to each MOSFET in the circuit becomes an important problem for reliability. However, directly evaluating the reliability of the MOSFET in the circuit is difficult, the design is carried out by using a duty ratio defined in Expression (1):

ΔVth_circuit(t)=ΔVth_{—}dc(t×Duty Ratio) (1)

where ΔVth_circuit(t) is a threshold voltage shift of an nMOSFET or a pMOSFET present in the circuit at a time t, and ΔVth_dc(t) is a threshold shift amount under DC conditions with respect to the single nMOSFET or pMOSFET.

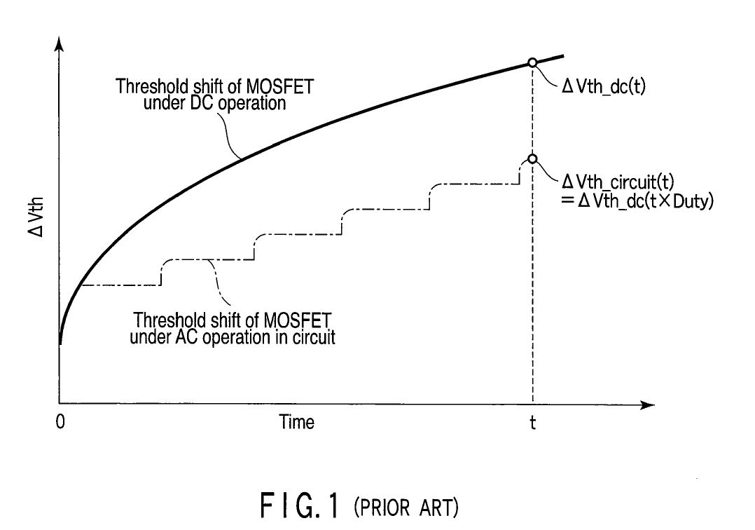

FIG. 1 schematically shows a relationship of Expression (1). The threshold shift amount ΔVth_dc(t) at the time t when an NBTI reliability test is conducted with respect to such a single pMOSFET as shown in FIG. 3 is a curve indicated by a solid line. Since a stress voltage is steadily applied to the pMOSFET, the threshold voltage shift amount monotonously increases with respect to time.

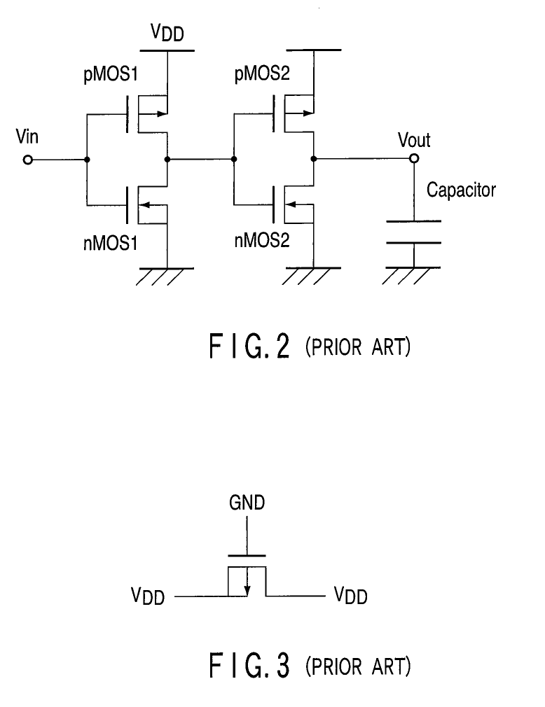

On the other hand, for example, the threshold voltage shift amount ΔVth_circuit(t) of a pMOS1 based on the NBTI when an appropriate waveform is input to the circuit depicted in FIG. 2 is such a curve as indicated by a dotted line. Since an AC waveform is input to the circuit, there is a time that the stress voltage is not applied to the pMOS1. Therefore, the threshold shift amount basically increases in a staircase pattern with respect to time. The duty ratio corresponds to a conversion coefficient used when representing a MOSFET deterioration amount in the circuit by ΔVth_dc.

It is to be noted that Expression (1) represents a duty concerning the threshold voltage shift, but the duty is defined by the same technique in regard to a current deterioration ratio. This can be likewise applied to other deterioration phenomena. In the conventional circuit design, ΔVth_circuit(t) after a long time, e.g., 15 years is calculated based on a combination with ΔVth_dc(t) obtained from actual measurement on the assumption that the duty ratio has a fixed value when a fixed time passes.

However, a circuit designer can estimate ΔVth_circuit(t) only when a simple waveform is input to a simple circuit. Furthermore, a range of t can be known for only a shorter time than an operation guaranteed period. Thus, a “circuit reliability simulation technology” that carries out circuit simulation such as an SPICE with respect to an actual circuit and estimates ΔVth_circuit(t) from obtained information of a terminal voltage or a terminal current with respect to each MOSFET has been utilized. This technology has been evolved, and the present invention provides a semiconductor circuit deterioration simulation method which has a function of feeding back a dynamic change in circuit produced with deterioration in each circuit element to estimation of a deterioration amount and can estimate circuit characteristics after long-term deterioration in a short time and also provides a computer program medium thereof.

Embodiments according to the present invention will now be described hereinafter in detail.

### FIRST EMBODIMENT

First, a method for calculating a threshold voltage shift and a current deterioration ratio of a MOSFET and a method for reflecting calculated values in circuit simulation in this embodiment will now be described.

In this embodiment, besides the threshold voltage shift ΔVth involved by the BTI and the hot carrier deterioration, a deterioration amount is calculated from a drain current deterioration ratio ΔID/ID in order to reflect the reduction of mobility due to the deterioration.

Since the threshold voltage shift and the current deterioration ratio caused by the BTI or the hot carrier increase with stress time, each of them can be represented as a function of time. Though they could be expressed in arbitrary functions, a threshold voltage shift and a drain current deterioration ratio represented by, e.g., Expression (2) and Expression (3) can be used:

ΔVth=A×t^{B}≡F(t) (2)

ΔI_{D}/I_{D}=C×t^{D}≡G(t) (3)

It is to be noted parameters A to D are functions of a terminal voltage or a terminal current, and they are modeled from a result of a reliability evaluation test under DC conditions. Moreover, a drain current deterioration ratio is, for example, expressed as the following ratio of a drain current at VG=VD=VDD (nMOS) or VSS (pMOS) before deterioration and a drain current when a stress voltage is applied for a time t:

ΔI_{D}/I_{D}=ΔI_{D}(t)/I_{D}(0) (4)

However, since AC signal is input to the circuit, the threshold voltage shift or the drain current deterioration ratio of each MOSFET in the circuit does not always progress as shown in FIG. 1. Therefore, F(t) or G(t) cannot be directly incorporated into the circuit reliability simulation. Thus, the deterioration amount is calculated in accordance with the following method on the assumption that the threshold voltage shift or the drain current deterioration ratio at the time t is represented as time t_{eff} (=Duty×t) during which the stress voltage is effectively applied to the MOSFET.
Threshold voltage shift

t_{eff}_{_{—}}^{dvth}=F⁻¹ (ΔVth(t)) (5)

ΔVth(t+δt)=ΔVth(t)+dF/dt(t_{eff}_{_{—}}^{dvth})×δt (6)
Current deterioration ratio

t_{eff}_{_{—}}^{dld}=G⁻¹(ΔI_{D}/I_{D}(t)) (7)

ΔI_{D0}/I_{D}(t+δt)=ΔI_{D}/I_{D}(t)+dG/dt(t_{eff}_{_{—}}^{dld})×δt (8)

Since dF/dt or dG/dt becomes 0 under conditions that deterioration in the MOSFET does not progress and dF/dt or dG/dt becomes a non-zero value under conditions that deterioration advances, the deterioration amount at t+δt can be accurately estimated.

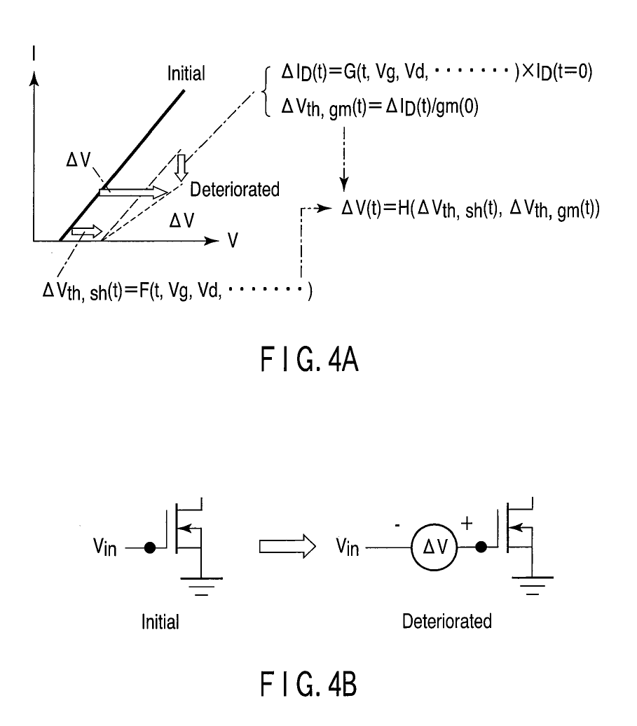

The threshold voltage shift and the current deterioration ratio calculated by such a method are reflected in the circuit simulation using a method depicted in FIGS. 4A and 4B. FIG. 4A is an explanatory view of a function representing a dynamic deterioration amount of the MOSFET, and FIG. 4B shows how this function is used as a voltage source to be inserted in a gate electrode of the MOSFET in series. In this embodiment, both the threshold voltage shift and the current deterioration are considered as phenomena that shift a flat band voltage, and a voltage source corresponding to a deterioration amount is inserted in the gate electrode. The threshold voltage shift is directly converted to the voltage source, and the current deterioration ratio is converted to a voltage source based on the following expressions:

ΔVth,gm(t)=ΔID(t)/gm(0) (9)

ΔID(t)=ΔID/ID(t)×ID(0) (10)

gm(0)=dID/dVG(0) (11)

However, data of the current deterioration ratio includes a reduction of drain current due to the threshold voltage shift. Further, the data of the current deterioration ratio is consistently deterioration data when V_{G}=V_{D}=V_{DD} or V_{SS} is achieved. Thus, based on Expression (12) and Expression (13), ΔV is calculated from ΔVth,shift (ΔVth,shift will be referred to as ΔVt,sh hereinafter) and ΔVth,gm, and it is used as a voltage source representing the deterioration. As a result, the deterioration amount for an arbitrary voltage can be expressed without counting the influence of the threshold voltage shift over again. It is to be noted that Expression (12) and Expression (13) are expressions for the nMOSFET, the same calculation is executed in regard to the pMOSFET. It is to be noted that Vth is a threshold voltage of the MOSFET before the deterioration.

When VG−Vth−Δth,sh<0,

ΔV=ΔVth,sh (12)

When VG−Vth−ΔVth,sh>0,

ΔV=ΔVth,sh+(ΔVth,gm−ΔVth,sh)×(VG−Vth−ΔVth,sh)/(VDD−Vth−ΔVth,sh) (13)

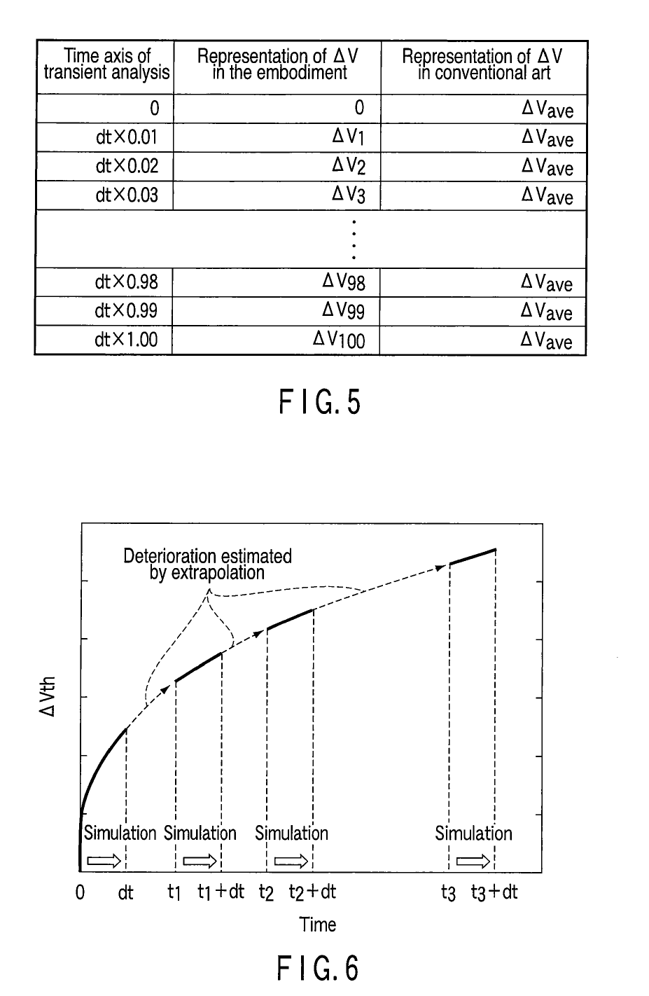

Furthermore, ΔV is characterized in that it dynamically varies like ΔV₁, ΔV₂, . . . , as shown in FIG. 5 while transient analysis is performed in the circuit simulation. This is an intrinsic characteristic of this embodiment, and a deterioration amount has a fixed value irrespective of time even in the transient analysis in the conventional art described in, e.g., Patent Document 2 or the like (ΔVave). For example, since a change in deterioration amount with time is very large on the initial stage of deterioration, a difference between calculation results obtained by this embodiment and the conventional art clearly appears, and this embodiment enables the more accurate simulation. However, such a “voltage source which changes with time” is not a special function, and it is a function provided as a standard in the general circuit simulator.

That is, in the circuit reliability simulation at t=tᵢ to tᵢ+dt, “the MOSFET deteriorates while “t=0 to tᵢ but it does not deteriorate while t=tᵢ to tᵢ+dt” in the conventional art, whereas this embodiment has a concept “deterioration likewise occurs at t=tᵢ to tᵢ+dt that the simulation is performed”.

Before explaining a simulation procedure of this embodiment, a method for calculating deterioration amount at time t will now be described with reference to a conceptual diagram of FIG. 6. This embodiment is characterized in that a duty ratio fluctuation of the MOSFET involved by deterioration can be dynamically fed back to the circuit simulation. However, to ascertain circuit characteristics after, e.g., 15 years while effectively exploiting this characteristic, the circuit reliability simulation for 15 years must be carried out, and a tremendous simulation time is required.

Therefore, in this embodiment, “short-time circuit reliability simulation at t=tᵢ to tᵢ+td” and “estimation of a MOSFET deterioration amount at t=tᵢ₊₁ based on extrapolation” are alternately repeated to realize a great reduction in simulation time. A time t=tᵢ₊₁ at which the circuit reliability simulation is effected can be arbitrarily determined, but it is determined based on, e.g., Expression (14) in this embodiment:

tᵢ₊₁=(tᵢ+dt)×Factor (Factor>0) (14)

As Factor, an appropriate number can be selected in accordance with a required accuracy for the simulation.

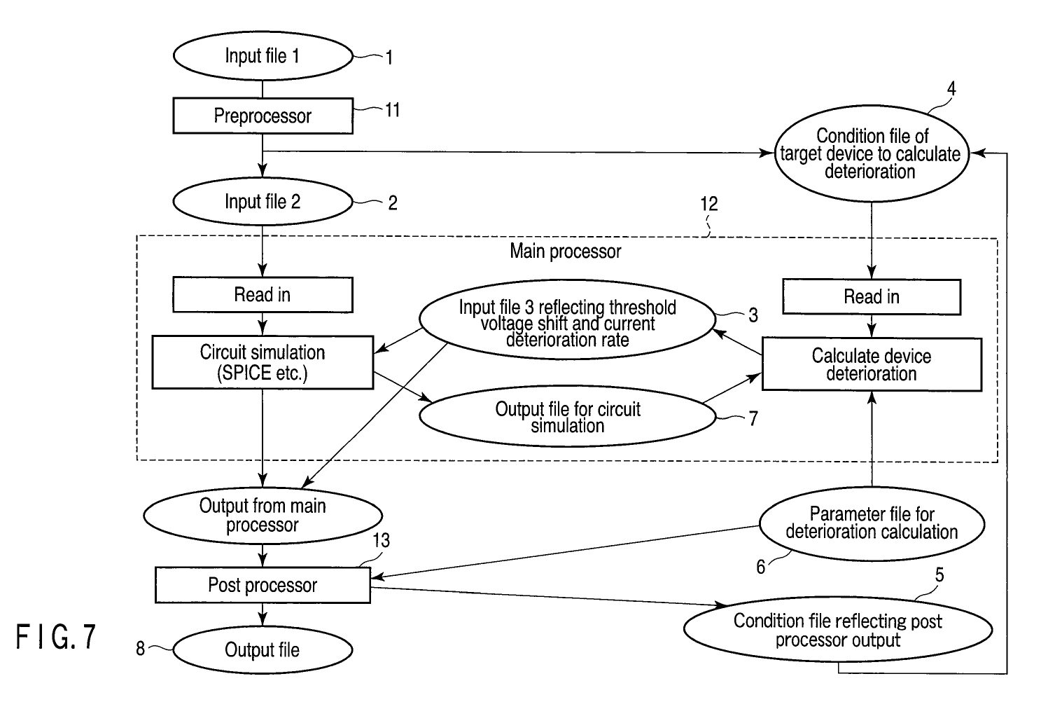

FIG. 7 is a conceptual drawing showing a configuration and an overall flow of this embodiment. Functions in this embodiment are classified based on three processors, i.e., a pre-processor 11, a main processor 12, and a post-processor 13 to be explained for convenience's sake.

The pre-processor 11 processes a circuit simulation input file 1 prepared by a user into a format appropriate for the circuit reliability simulation and creates an input file 2. The input file 1 is a regular circuit simulation input file, and the input file 2 is obtained by changing a format of the input file 1 for circuit reliability evaluation.

The main processor 12 executes each of the circuit simulation such as an SPICE and a calculation of each MOSFET deterioration amount based on a result of this simulation and Ireading from a condition (list) file 4 for a device that performs a deterioration calculation and a deterioration calculation parameter file 6 once, or alternately executes these operations. This “function for performing a calculation”is a newly devised scheme, and this enables improving a calculation accuracy and reflecting a change in a terminal voltage or a terminal current of each MOSFET involved by deterioration dynamically (in terms of a time function) in the deterioration amount calculation.

After the main-processor is executed, an input file 3 having a result (e.g., a threshold voltage shift or a current change ratio) of the main processor 12 reflected therein is created to be fed back to the circuit simulation. Then, the post-processor 13 executes extrapolation processing, replaces the condition file 4 with a condition file 5 having the result of the post-processor 13 reflected therein, and effects feedback to reading of a device deterioration amount.

When the circuit simulation with the read device deterioration is again carried out and repeated and a desired lifetime is reached, an output file 8 is output to terminate the operation.

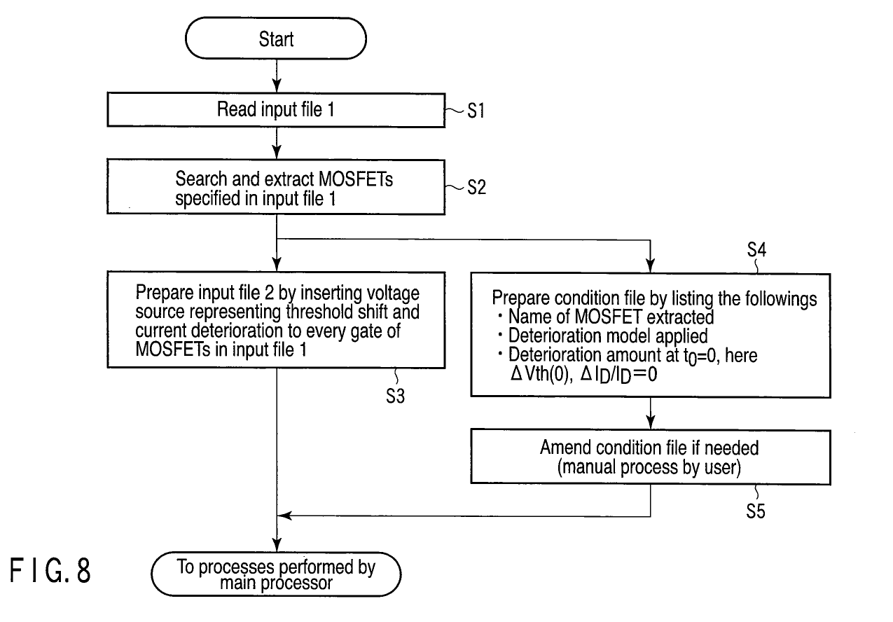

FIG. 8 is a flowchart showing an operation procedure in the pre-processor. A description will now be given while using reference numerals in FIG. 7. First, the input file 1 for the circuit simulation prepared by a user is read in step 1 (S1), and information of each MOSFET in the input file 1 is extracted in step 2 (S2). Additionally, the input file 2 is newly created in which the voltage source representing the deterioration described in conjunction with FIG. 4A is inserted into the gate electrode of each MOSFET extracted in S2 (S3). However, since each MOSFET does not deteriorate at t=0, each of ΔVth,sh and ΔVth,gm representing the threshold voltage shift and the current deterioration is 0 V.

Further, at the same time, a list file 4 in which a name of each MOSFET extracted in S2, a deterioration model to be applied (BTI or a hot carrier in this embodiment), and ΔVth,sh and ΔVth,gm utilized as initial values for a calculation are specified is created in step 4 (S4). Each MOSFET specified in this list file 4 is processed as a target MOSFET to be caused to deteriorate in this embodiment.

Usually, the control directly advances to processing of the main processor 12, but some of the MOSFETS alone in the circuit may be caused to deteriorate depending on the simulation purpose. For example, this corresponds to execution of sensitivity analysis for searching a MOSFET that contributes to the deterioration of the entire circuit to the maximum extent from the circuit. In this case, names of MOSFETs which do not deteriorate are deleted from the list file 4 created in S4. Further, the initial values of ΔVth,sh and ΔVth,gm can be corrected. As a result, simulation that a state where the deterioration has advanced to some extent is represented as t=0 can be carried out. However, a user must manually perform this processing. This is determined as step 5 (S5).

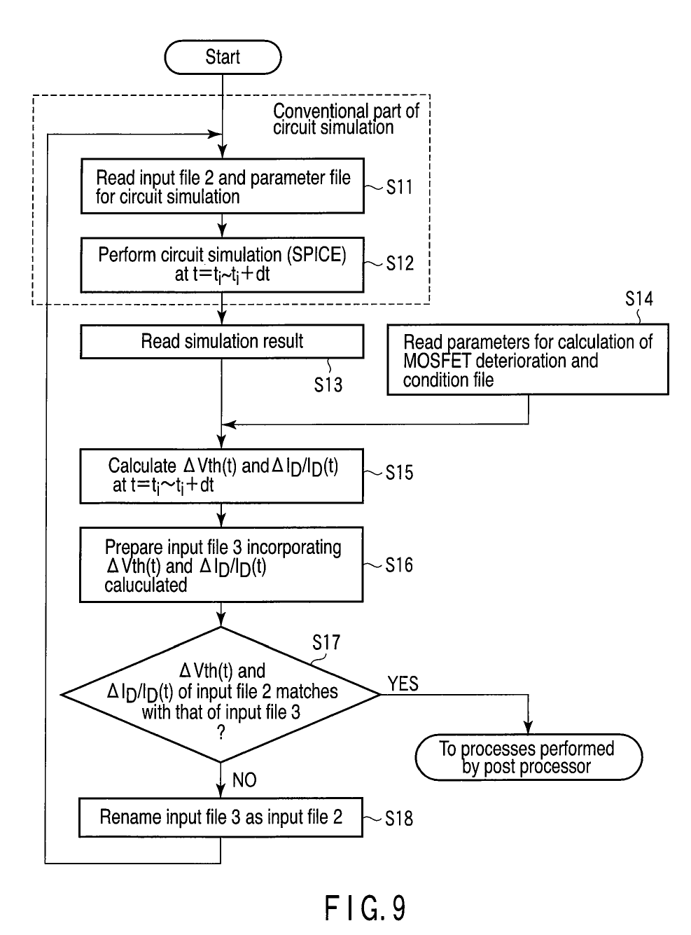

FIG. 9 is a flowchart showing an operation procedure carried out in the main processor 12. First, the input file 2 created at S3 and the circuit simulation parameters are read in step 11 (S11), and the circuit simulation at t=tᵢ to tᵢ+dt (ti=0 is included) is performed in step 12 (S12). S11 to S12 are a function of the existing circuit simulation main body, whereby information of the terminal voltage or the terminal current at each MOSFET in the circuit is output.

Then, an output file 7 as a result of the simulation is read in step 13 (S13), and a MOSFET deterioration amount calculation parameter file 6 and the condition file 4 created at S4 are read in step 14 (S14). The deterioration amount calculation parameters read at S14 are, e.g., the parameters A to D used in Expressions (2) and (3), very small in number as compared with the number of parameters used in the conventional art (see, e.g., “An Integrated Modeling Paradigm of Circuit Reliability for 65 nm CMOS Technology” by Wenping Wang et al., IEEE 2007 CICC).

Subsequently, in step 15 (S15), a threshold voltage shift ΔVh and a current deterioration ratio ΔID/ID with respect to each deterioration model are calculated for each MOSFET. Further, in step 16 (S16), the threshold voltage shift ΔVth and the drain current deterioration ratio ΔID/ID are converted into ΔVth,sh and ΔVth,gm based on the method depicted in FIG. 4A, and the input file 3 in which these values are reflected is created.

Finally, in step 17 (S17), a convergence judgment is made upon whether ΔVth,sh and ΔVth,gm specified in the input file 2 coincide with those in the input file 3. If a difference between ΔVth,sh and ΔVth,gm specified in input file 2 and those in input file 3 is large, a name of the input file 3 is changed to that of the input file 2 in step 18 (S18) and the processing at S11 and the subsequent steps is again carried out. If the difference is sufficiently small, it is determined that the convergence is attained, the circuit reliability simulation at t=tᵢ to tᵢ+dt (including tᵢ=0) is terminated, and the control proceeds to processing executed by the post processor 13.

It is to be noted that the circuit reliability simulation has not been conducted yet when the pre-processor 11 performs first, ΔVth in the condition file 4 is 0. When the operation is performed by the main processor 12 and contents in the input file 3 are fed back to the input file 2, any value is specified as ΔVth as a result of calculating the deterioration amount. When this feedback is repeated, a dynamic deterioration amount of ΔVth at this point in time (t=tᵢ to tᵢ+dt) is determined.

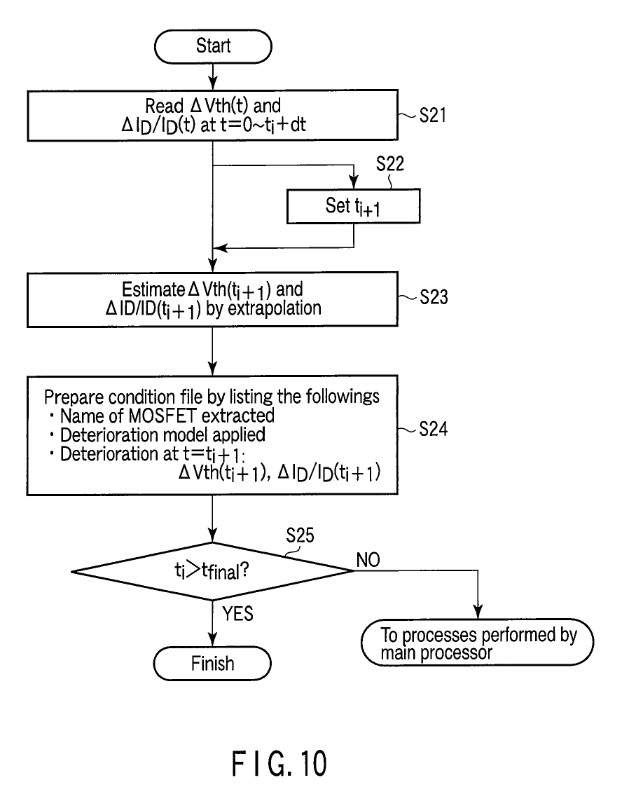

FIG. 10 is a flowchart showing a procedure of an operation executed by the post-processor 13. When the circuit reliability simulation from the beginning to t=tᵢ to tᵢ+dt is completed, data of the threshold voltage shift ΔVth and the drain current deterioration ratio ΔID/ID at each of t=0 to 0+dt, t₁ to t₁+dt, t₂ to t₂+dt, . . . , tᵢ to tᵢ+dt has been already stored. Thus, in step 21 (S21), all the pieces of data are first read.

Then, in step 22 (S22), tᵢ₊₁ is determined from information of a time tᵢ+dt read at S21 and Expression (14). Further, the threshold voltage shift ΔVth and the drain current deterioration ratio ΔID/ID for each deterioration model of each MOSFET at t=tiᵢ₊₁ are estimated by extrapolation, from the information obtained in S21 and S22, (S23). It is to be noted that the specific extrapolation method will be described later.

Then, in step 24 (S24), the condition file 5 having a result of the extrapolation specified therein is created. Contents in the condition file 5 specifically include a name of each extracted MOSFET, a deterioration model to be applied, and the threshold voltage shift ΔVth and the drain current deterioration ratio ΔID/ID at t=tᵢ₊₁. Furthermore, in step 25 (S25), t=tᵢ is compared with a time t_{final} specified by a user, e.g., 15 years in a magnitude relationship, and the control returns to the processing performed by the main processor 12 when t=tᵢ has not reached 15 years. At this time, the control returns to step 14 of the main processor to again read the deterioration amount at t=tᵢ₊₁ specified in the condition file 5 at S24, and this read value is used for the deterioration calculation at S15. If t=tᵢ has reached t_{final}, the output file 8 is output to terminate the operation.

FIG. 11 is a flowchart concerning an extrapolation method for a deterioration amount used in step 23 (S23) in this embodiment. As explained in conjunction with FIG. 10, a deterioration amount at t=0 to tᵢ to tᵢ+dt (data of the threshold voltage shift ΔVth or the drain current deterioration ratio ΔID/ID) and tᵢ₊₁ are input as extrapolation data.

In this embodiment, a least-squares method is adopted to derive a fitting function for these pieces of data, and this data is utilized to estimate a deterioration amount at t=tᵢ₊₁. However, when deriving the fitting function, t=0 to δt is not a fitting target. That is because an accuracy for fitting may be lowered when data on the initial stage of deterioration is included as shown in FIG. 12.

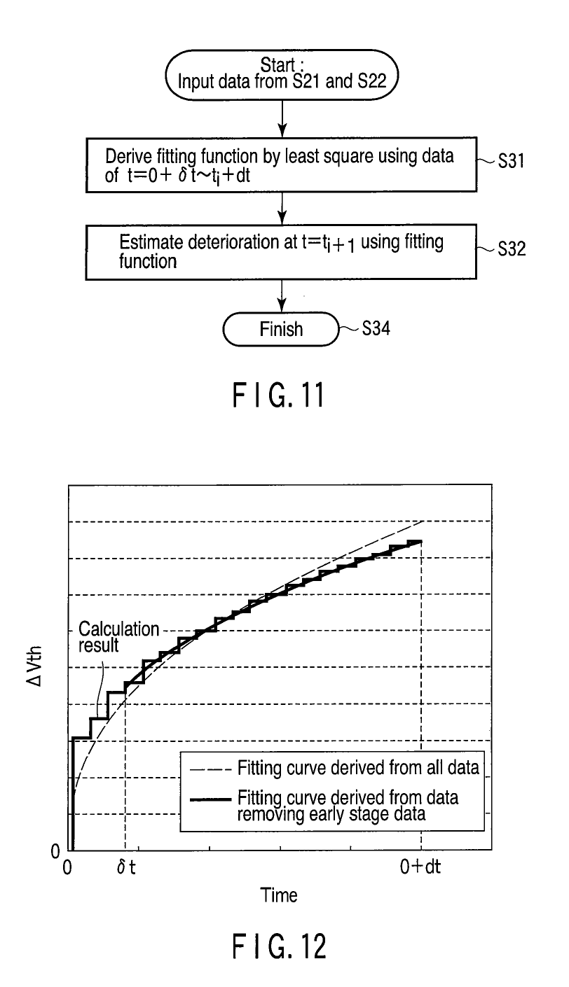

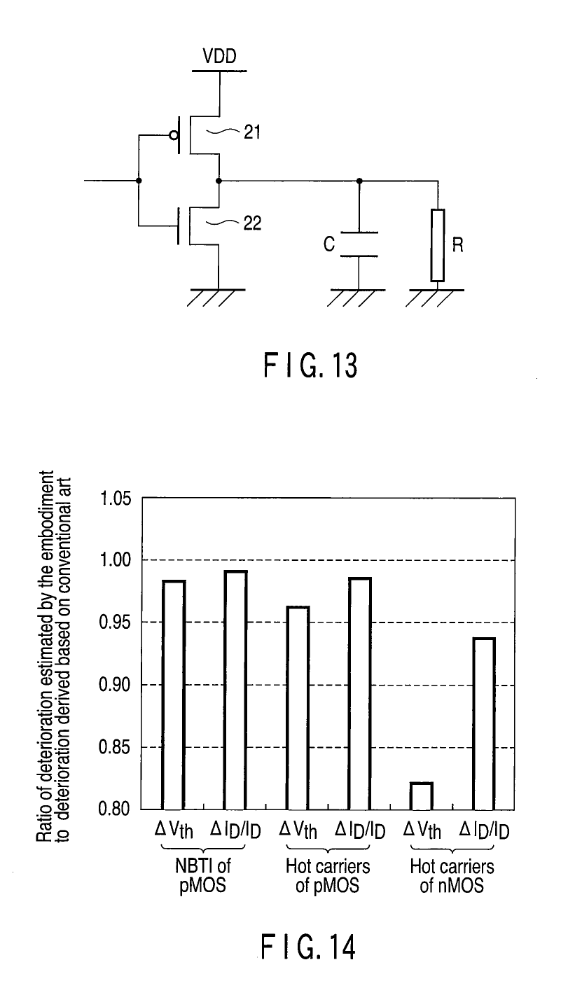

To confirm an effect of the simulation method according to this embodiment, the circuit reliability simulation was performed with respect to a circuit shown in FIG. 13. In FIG. 14, a threshold shift and a current deterioration ratio of the nMOSFET or the pMOSFET 21 in FIG. 13 after 15 years obtained according to the embodiment are shown as ratios with respect to a threshold shift and a current deterioration ratio obtained according to the conventional method. It is to be noted that the nMOSFET alone deteriorates when calculating a deterioration amount of the nMOSFET. This setting is adopted in order to prevent a change in a terminal voltage or a terminal current caused by the deterioration of the pMOSFET 22 from modulating a deterioration amount of the nMOSFET 21. A deterioration amount of the pMOSFET 21 is calculated in the same manner.

The conventional method basically adopts a method of “estimating a deterioration amount from a terminal voltage or a terminal current in an ideal state”. That is, a deterioration amount of each MOSFET is independently calculated. When evaluating an effect of this embodiment for comparison with this method, the deterioration of the nMOSFET or the pMOSFET alone is taken into consideration.

As shown in FIG. 14, it can be understood that the deterioration amount calculated according to this embodiment is smaller than that calculated according to the conventional method. That is because this embodiment can appropriately reflect how the change of a duty ratio due to the deterioration in the simulation.

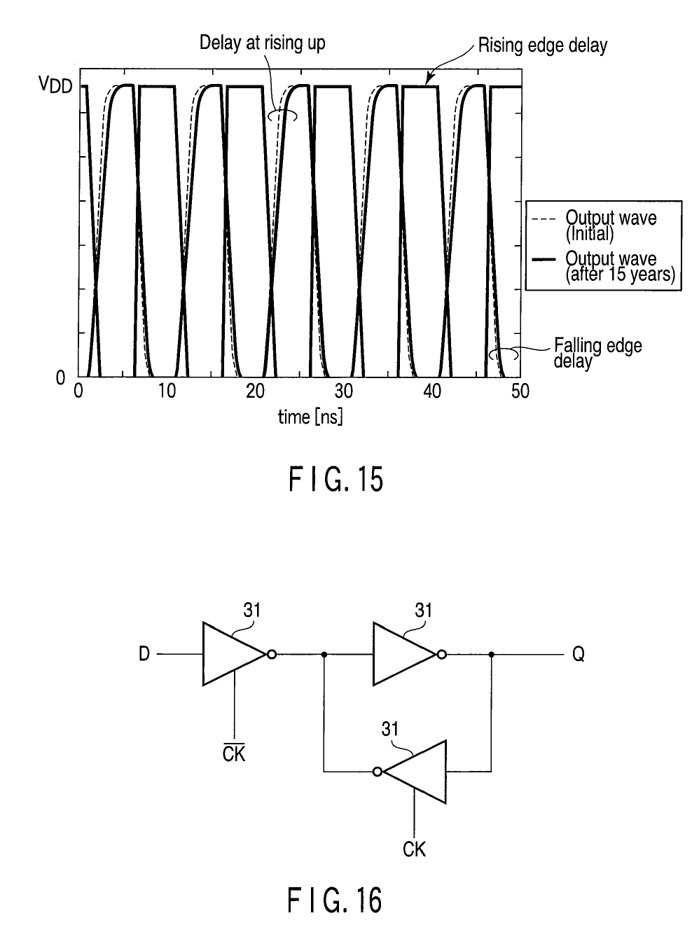

FIG. 15 shows circuit characteristics after 15 years obtained according to this embodiment. Here, the simulation is carried out while considering both the deterioration of the pMOSFET and that of the nMOSFET. The delay in a rising edge and a falling edge of an output waveform due to the deterioration of the pMOSFET 21 and that of the nMOSFET 22 can be confirmed.

An example that an operation time in this embodiment is improved as compared with that in the conventional art will now be explained. According to a calculation technique having the best estimation accuracy in the conventional art (e.g., a technique in U.S. Pat. No. 7,292,968), when performing the circuit reliability simulation at a time t=0 to t_{end}, a calculating section is divided into [0, t₁], [t₁, t₁*2], [t₁*t2, t₁*3], . . . , [t_{end}−t₁, t_{end}]. Further, deterioration parameters are updated every time the calculation of each section is terminated. However, in the conventional art, to obtain the same estimation accuracy as that of this embodiment, the section must be finely divided, whereby the simulation cannot be executed in a realistic time.

A situation where the circuit reliability simulation at t=0 to 1000 ns is performed with respect to a circuit depicted in FIG. 16 will now be considered, for example. In this embodiment, since a deterioration amount can be dynamically changed with respect to time, as shown in FIG. 5, the minimum required number of times of the circuit simulation is 1. When performing this evaluation, the number of times of the simulation in the main processor is determined as 1 (in other words, the main processor does not perform the S17 to S11 by way of S18) to provide the same conditions as a comparative example.

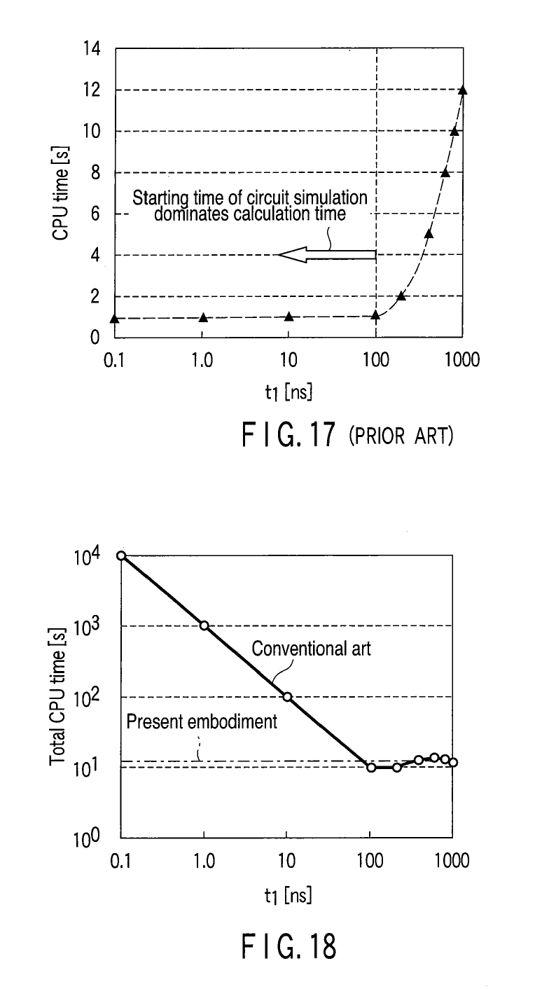

On the other hand, in the conventional art, t₁ must be finely divided to improve a deterioration amount estimation accuracy. It is expected that a CPU processing time required for one section is decreased as t₁ is reduced, but the CPU time actually gradually approximates a fixed value as shown in FIG. 17. That is because the CPU time is dominated by a starting time of the circuit simulation.

When t₁ is further finely divided, the circuit simulation must be activated again and again, and it is to be noted that a tremendous time is consumed for this activation.

FIG. 18 shows the dependence on t₁ by an entire CPU time required for performing the circuit simulation at t=0 to 1000 ns in the conventional art. It can be understood that a time of 10,000 seconds or more is required for effecting the circuit reliability simulation at t=0 to 1000 ns because of the factor explained in conjunction with FIG. 17. On the other hand, a necessary CPU time is 10 seconds or a slightly longer time in this embodiment.

The simulation time in this embodiment is short because the deterioration of the MOSFET is considered as the voltage source which dynamically changes with respect to the time t rather than a change in parameter of the circuit simulation.

As explained above, in this embodiment, the deterioration calculation is represented as a time function. As a method for determining the function, the bias condition dependence is measured from an experiment, and a fitting function (e.g., y=At^{B}) is assumed. Additionally, A or B is obtained as a function of a voltage or a current. However, a function format of A or B is not determined in particular, and an appropriate function is selected to reconstruct actual measurement.

Further, in this embodiment, parameters are not prepared for each deterioration calculation, but the deterioration is represented in the form of the voltage source, the function can be used irrespective of a scheme of a circuit simulation model.

As explained above, the first embodiment has a function of using the fitting function to determine the deterioration as the time function and alternately performing the circuit simulation and the deterioration calculation to feed back a dynamic change in circuit caused with the deterioration of each circuit element to the deterioration amount estimation, thereby estimating circuit characteristics after long-term deterioration in a short time.

### SECOND EMBODIMENT

Since a deterioration simulation method according to the second embodiment is the same as that in the first embodiment except an extrapolation method, the extrapolation method alone will be explained.

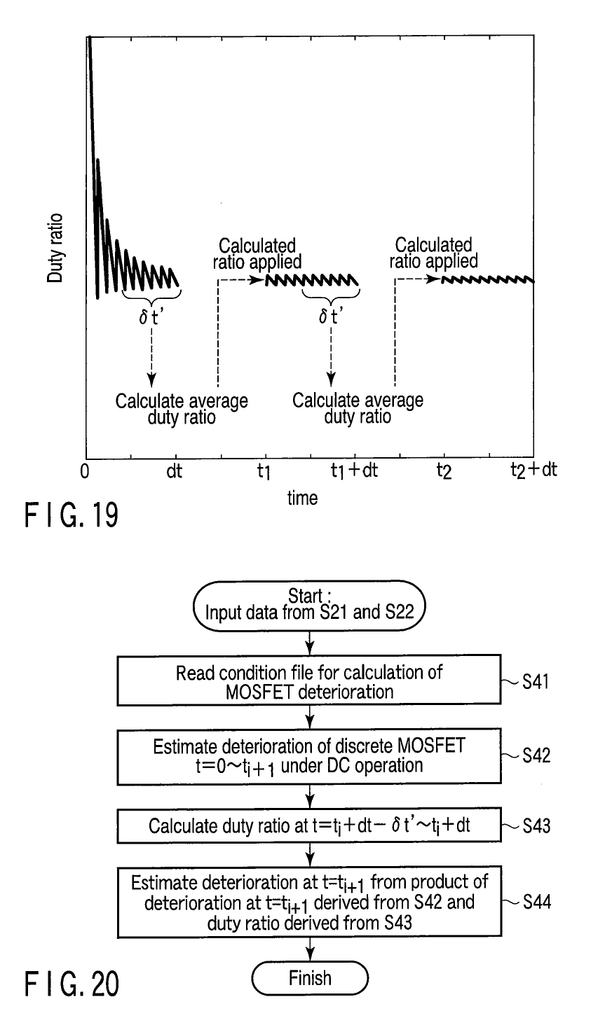

In the second embodiment, the extrapolation method using a duty ratio depicted in FIG. 19 is adopted. When the duty ratio is calculated with respect to each MOSFET in a circuit, such a behavior as depicted in FIG. 19 is generally demonstrated. Although the duty ratio greatly fluctuates on the initial stage of deterioration, it gradually approximates a fixed value. This embodiment utilizes this characteristic.

FIG. 10 is a flowchart concerning the extrapolation method in this embodiment. As described in conjunction with FIG. 20, data of a deterioration amount (a threshold voltage shift ΔVth or a current deterioration ratio ΔID/ID) at t=0 to tᵢ+dt and tᵢ₊₁ are input as extrapolation data. Then, a parameter file 7 for a MOSFET deterioration amount calculation is read in step 41 (S41), and a deterioration amount of a single MOSFET at t=0 to tᵢ+dt under DC stress conditions to which reference is made in the duty ratio calculation is calculated in step 42 (S42).

Subsequently, in step 43 (S43), an average value of the duty ratios at t=tᵢ+dt−δt′ to tᵢ+dt is calculated. Assuming that the duty ratio obtained here is stored for an extrapolation period t=tᵢ+dt to tᵢ₊₁, a deterioration amount of the MOSFET in the circuit at t=tᵢ₊₁ can be estimated from a product of this duty ratio and the deterioration amount of the single MOSFET at t=tᵢ₊₁ under the DC stress conditions.

It is to be noted that t=tᵢ+dt−δt′ to tᵢ+dt is used instead of t=tᵢ to tᵢ+dt in the duty ratio calculation because the duty ratio at t=tᵢ to tᵢ+dt−δt′ may largely fluctuate in some cases. Further, the average duty ratio in FIG. 19 is obtained by calculating several duty ratios during the time t=tᵢ+dt−δt′ to tᵢ+dt and averaging them.

In the second embodiment, operations in a pre-processor and a main processor are the same as those in the first embodiment, the extrapolation method in the pre-processor alone is different, and hence an improvement in efficiency of an operation time described in the first embodiment can be likewise demonstrated.

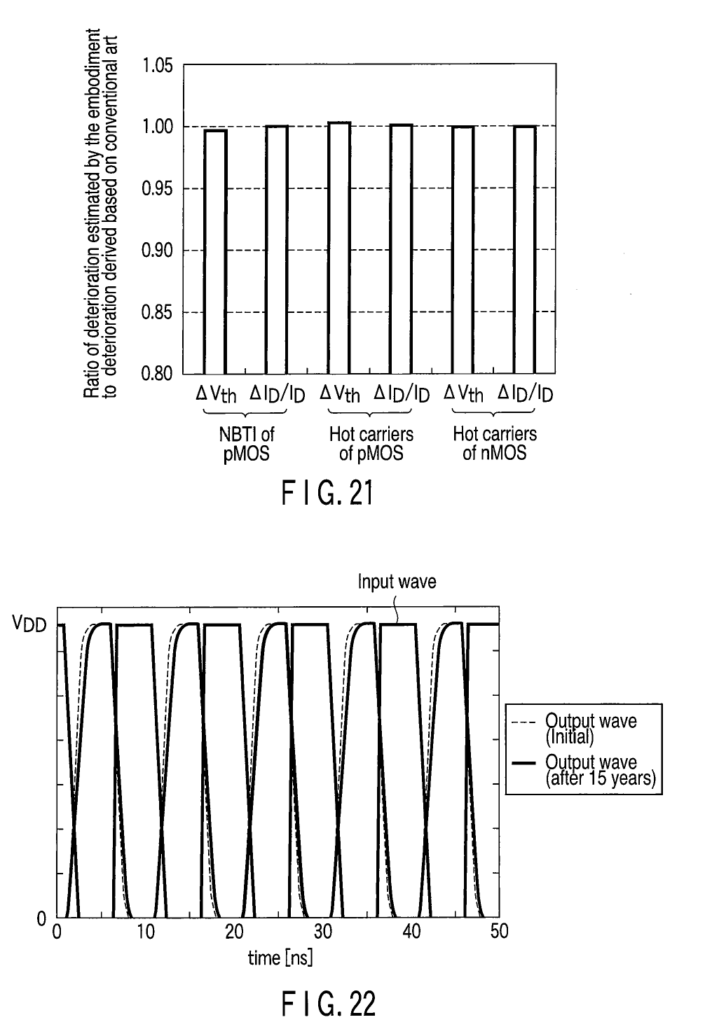

FIG. 21 is a graph in which each deterioration amount calculated according to this embodiment is compared with a counterpart calculated according to the conventional method, but there is almost no difference. It is considered that the duty ratio is presumed as a fixed value when calculating an extrapolation amount at tᵢ₊₁ from a result of tᵢ to tᵢ+dt. Therefore, an accuracy improving effect cannot be always obtained, but the improvement in efficiency of the operation time can be acquired like the first embodiment.

Moreover, the extrapolation method according to the second embodiment is characterized in that it is superior in robustness at the time of the extrapolation processing to the extrapolation method according to the first embodiment. In the simulation according to the first embodiment, a situation that a cyclic waveform is input to the circuit and the deterioration increases with time (increase with y=At^{B}) is considered, but an extrapolation value takes an unnatural value when an unexpected behavior is demonstrated (when an increase with y=At^{B} is not observed) for some reason.

On the other hand, according to the extrapolation method using the duty ratio, an unnatural value is not generated, and an adequate extrapolation result can be obtained.

FIG. 22 shows circuit characteristics after 15 years obtained by this embodiment. In this example, the simulation is effected while considering both the deterioration of the pMOSFET 21 and that of the nMOSFET 22. The delay in a rising edge and a falling edge of an output waveform due to the deterioration of the pMOSFET 21 and that of the nMOSFET 22 can be confirmed.

It is to be noted that the technique described in each of the first and second embodiments can be realized as a program which can be executed by a computer, and the program can be recorded on a recording medium such as a magnetic disk, an optical disc such as a CD, a DVD, or an MO, or a semiconductor memory to be applied to various devices or transmitted through a communication medium to be applied to various devices.

Additionally, in the foregoing embodiments, the example where the BTI and the hot carrier deterioration are introduced as the deterioration models of the MOSFETs has been described. However, the present invention is not restricted thereto, and any other deterioration model (e.g., TDDB) can be introduced as long as the model is defined to include a terminal voltage or a terminal current of a device.

According to the foregoing embodiments, the semiconductor circuit deterioration simulation method which has a function of feeding back a dynamic change in circuit caused with deterioration of each circuit element to deterioration amount estimation and can estimate circuit characteristics after long-term deterioration in a short time and the computer program medium thereof are provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor circuit deterioration simulation method for a circuit using a computer including a pre-processor, a main processor, and a post processor, comprising:
creating by the pre-processor, a second input file pre-processed to enable inserting a dynamic voltage source associated with a fluctuation in voltage/current characteristics into each gate terminal of the plurality of MOSFETs in series, based on a first input file having the circuit including a plurality of MOSFETs specified therein, and a first deterioration calculation condition file including a dynamic deterioration model associated with elapse of a time, to send the second input file and the first deterioration calculation condition file to the main processor;
performing first circuit simulation with respect to the second input file by the main processor and calculating a dynamic deterioration amount after elapse of a short time dt from a time tᵢ (i=an integer greater than or equal to 0) of the plurality of MOSFETs based on the dynamic deterioration model by using the first deterioration calculation condition file to create a third input file, to send the third input file to the post processor;
performing, by the post processor, an estimation calculation of a dynamic fluctuation amount at a time tᵢ₊₁ (where tᵢ₊₁−tᵢ>dt) by extrapolation based on the third input file to create a second deterioration calculation condition file, to feed back the second deterioration calculation condition file to the main processor;
calculating, by the main processor, dynamic deterioration amounts of the plurality of MOSFETs at tᵢ₊₁ to tᵢ₊₁+dt with contents in the second deterioration calculation condition file based on the dynamic deterioration model, and then carrying out second circuit simulation having the dynamic deterioration amount reflected therein, to send the post processor;
repeating processing from the estimation calculation based on the extrapolation to the second circuit simulation by the post processor until tᵢ reaches a simulation target time t_{final}; and
outputting from the post processor an output file in which the second circuit simulation is reflected when tᵢ reaches t_{final}.

2. The method according to claim 1, wherein the dynamic voltage source is represented as a function of a first voltage source associated with a change in threshold voltage and a second voltage source associated with a drain current change ratio.

3. The method according to claim 2, wherein the second voltage source is obtained by dividing the drain current change ratio by a mutual conductance as a time function.

4. The method according to claim 1, wherein the first deterioration calculation condition file includes the dynamic deterioration model for each of the plurality of MOSFETs and a list in which an initial value of the voltage/current characteristics is specified.

5. The method according to claim 1, further including correcting the first deterioration calculation condition file by a manual operation as required after the creation of the first deterioration calculation condition file by the pre-processor.

6. The method according to claim 1, wherein the creation of the second deterioration calculation condition file by the post processor includes deriving a fitting function based on a least-squares method by using data of an initial value to a time tᵢ+dt and performing an estimation calculation of the dynamic fluctuation amount.

7. The method according to claim 6, wherein the initial value is a value after elapse of a short time δt (where δt<dt) from a time 0.

8. The method according to claim 1, wherein the creation of the second deterioration calculation condition file by the post processor includes:
reading a deterioration amount of the voltage/current characteristics at a time 0 to tᵢ+dt;
estimating a DC deterioration amount of a single MOSFET at 0 to tᵢ₊₁ under DC stress conditions;
calculating an average duty ratio during a time t=ti+dt−δt′ to ti+dt (where δt′ is a short time having a relationship δt′<dt); and
estimating a deterioration amount at t=tᵢ₊₁ from a product of the DC deterioration amount and the average duty ratio.

9. The method according to claim 8, wherein the average duty ratio is obtained by calculating a plurality of duty ratios during the time t=tᵢ+dt−δt′ to tᵢ+dt and averaging the duty ratios.

10. A computer program medium having a program executed by a computer recorded therein, the program including a circuit deterioration simulation method for a circuit, the method comprising:
creating, based on a first input file having the circuit including a plurality of MOSFETs specified therein, a second input file pre-processed to enable inserting a dynamic voltage source associated with a fluctuation in voltage/current characteristics into each gate terminal of the plurality of MOSFETs in series, along with creating a first deterioration calculation condition file including a dynamic deterioration model associated with elapse of a time;
performing first circuit simulation with respect to the second input file and calculating a dynamic deterioration amount after elapse of a short time dt from a time tᵢ (i=an integer greater than or equal to 0) of the plurality of MOSFETs based on the dynamic deterioration model by using the first deterioration calculation condition file to create a third input file;
performing an estimation calculation of a dynamic fluctuation amount at a time tᵢ₊₁ (where tᵢ₊₁−tᵢ>dt) by extrapolation based on the third input file to create a second deterioration calculation condition file;
calculating dynamic deterioration amounts of the plurality of MOSFETs at tᵢ₊₁ to dt with contents in the second deterioration calculation condition file based on the dynamic deterioration mode, and then carrying out second circuit simulation having the dynamic deterioration amount reflected therein;
repeating processing from the estimation calculation based on the extrapolation to the second circuit simulation until tᵢ reaches a simulation target time t_{final}; and
outputting an output file in which the second circuit simulation is reflected when tᵢ reaches t_{final} to terminate the operation.

11. The computer program medium according to claim 10, wherein the dynamic voltage source is represented as a function of a first voltage source associated with a change in threshold voltage and a second voltage source associated with a drain current change ratio.

12. The computer program medium according to claim 11, wherein the second voltage source is obtained by dividing the drain current change ratio by a mutual conductance as a time function.

13. The computer program medium according to claim 10, wherein the first deterioration calculation condition film includes the dynamic deterioration model for each of the plurality of MOSFETs and a list in which an initial value of the voltage/current characteristics is specified.

14. The computer program medium according to claim 10, wherein effecting interruption to correct the first deterioration calculation condition file by a manual processing as required is possible after the creation of the first deterioration calculation condition file.

15. The computer program medium according to claim 10, wherein the creation of the second deterioration calculation condition file includes deriving a fitting function based on a least-squares method by using data of an initial value to a time tᵢ+dt and performing an estimation calculation of the dynamic fluctuation amount.

16. The computer program medium according to claim 15, wherein the initial value is a value after elapse of a short time δt (where δt<dt) from a time 0.

17. The computer program medium according to claim 10, wherein the creation of the second deterioration calculation condition file includes:
reading a deterioration amount of the voltage/current characteristics at a time 0 to tᵢ+dt;
estimating a DC deterioration amount of a single MOSFET at 0 to tᵢ₊₁ under DC stress conditions;
calculating an average duty ratio during a time t=ti+dt−δt′ to ti+dt (where δt′ is a short time having a relationship δt′<dt); and
estimating a deterioration amount at t=tᵢ₊₁ from a product of the DC deterioration amount and the average duty ratio.

18. The computer program medium according to claim 17, wherein the average duty ratio is obtained by calculating a plurality of duty ratios during the time t=tᵢ+dt−δt′ to tᵢ+dt and averaging the duty ratios.
